(19) United States
(12) Patent Application Publication
(10) Pub. No.: US 2024/0127723 A1
(43) Pub. Date: Apr. 18, 2024

(54) FLAG POLE ASSEMBLY

(71) Applicant: CPPC-MOLDING CO., LTD., Lukang Township (TW)

(72) Inventor: SHENG-PING LIANG, Lukang Township (TW)

(21) Appl. No.: 17/966,767

(22) Filed: Oct. 14, 2022

(51) Int. Cl. G09F 17/00

(52) U.S. Cl. CPC G09F 17/00; G09F 2017/005

(57) ABSTRACT

A flag holder assembly has: a flag holder and a flag. The flag holder has the two casing portions, the inner surface one of the casing is provided with several the positioning pins, a plurality of first fastening portions and at least one first clamping lip, and the inner surface of the other casing portion is provided with a plurality of positioning pins, a plurality of second fastening portions and at least one second clamping lip. One side of the two casing portions are both extended with a curved elastic member, and the two elastic members form a living hinge in between.

### BACKGROUND OF INVENTION

### Field of Invention

The present invention relates to a flag holder assembly.

### Description of the Related Art

Currently, small flags for being handed out taken or fixed at the front of the vehicle are mostly composed of a flag and a flag holder. The flag is a plastic sheet or a cloth body, and the surface is printed with a pattern. The flag holder is a round rod body, so that after the flag is wrapped around the flag holder and then glued or sewn on the flag holder.

However, the above conventional structure still has the following problems in practical application: the gluing or sewing process of the flag is time-consuming, and the labor cost required is high. Also, the flag is simply glued or sewed on the flag holder, so it is easy to cause the flag to loosen and wrinkle while being waved repeatedly or blown in the wind, which is a problem of insufficient bonding strength.

Therefore, it is desirable to provide a flag holder assembly to mitigate and/or obviate the aforementioned problems.

### SUMMARY OF THE INVENTION

An objective of present invention is to provide a flag holder assembly which is capable of improving the above-mention problems.

In order to achieve the above mentioned objective, a flag holder assembly has a flag holder and a flag.

The flag holder comprises a pair of casing portions, an inner surface of one casing portion having a plurality of positioning pins, a plurality of first fastening portions and at least one first clamping lip, an inner surface of the other casing portion having a plurality of positioning hole posts, a plurality of second fastening portions and at least one second clamping lip; both of the first clamping lip and the second clamping lip respectively having at least one enforcing rib connected to the respective casing portion, and one of the enforcing ribs has a concavity; wherein when the flag is placed between the two casing portions, the positioning hole posts engage with the positioning pins, and each second fastening portion locks with each corresponding first fastening portion to sandwich the flag between the two casing portions; the first clamping lip and the second clamping lip respectively clamp on each side of the flag to bend the flag to increase friction between the flag and the flag holder; both of the two casing portions respectively have a curved elastic member extending and connecting to each other forming a living hinge.

Other objects, advantages, and novel features of invention will become more apparent from the following detailed description when taken in conjunction with the accompanying drawings.

### BRIEF DESCRIPTION OF DRAWINGS

FIG. 1 is a three-dimensional combined view of a preferred embodiment according to the present invention.

FIG. 2 is a three-dimensional exploded view of the preferred embodiment according to the present invention.

FIG. 3 is a cross-sectional view of the casing portions not being aligned according to the present invention.

FIG. 4 is a cross-sectional view of the casing portions being closed according to the present invention.

FIG. 5 is a combined perspective view of the preferred embodiment according to the present invention.

FIG. 6 is a cross-sectional drawing of the preferred embodiment according to the present invention.

FIG. 7 is another cross-sectional drawing of the preferred embodiment according to the present invention.

FIG. 8 is a schematic drawing of the flag holder assembly breaking wind according to the present invention.

### DETAILED DESCRIPTION OF THE PREFERRED EMBODIMENT

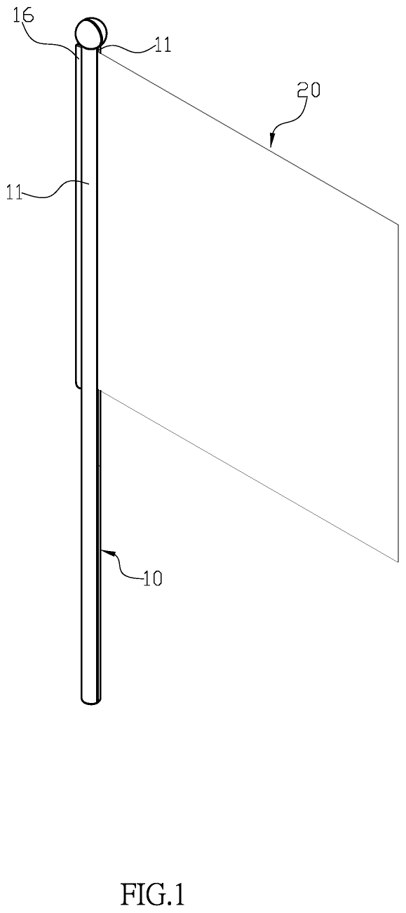

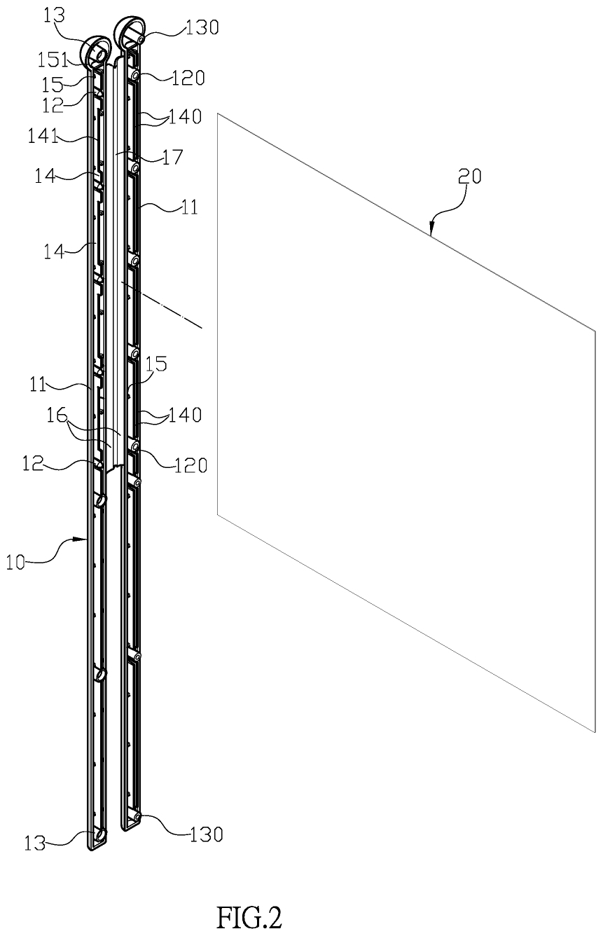

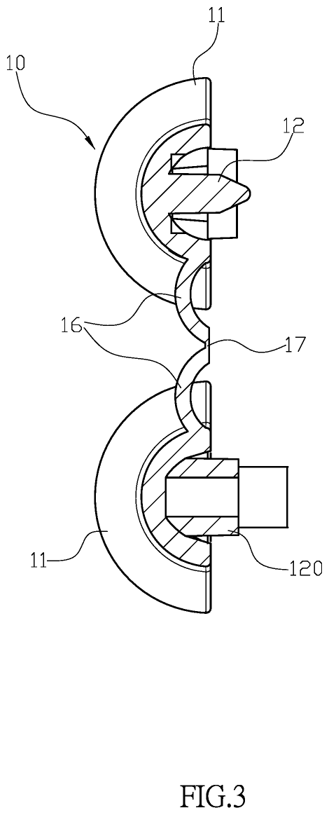

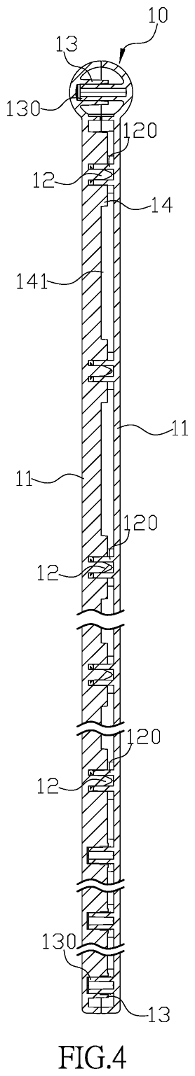

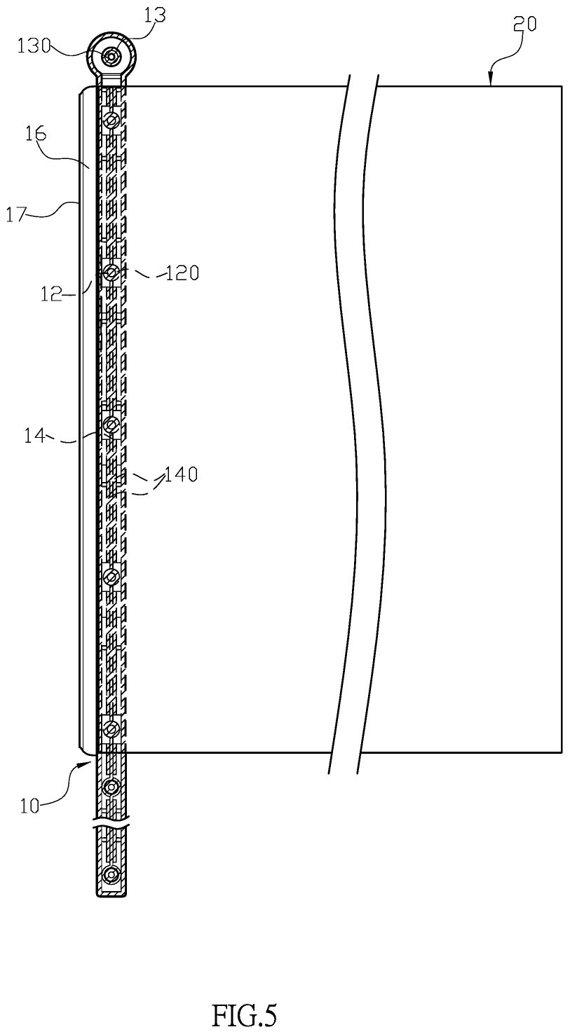

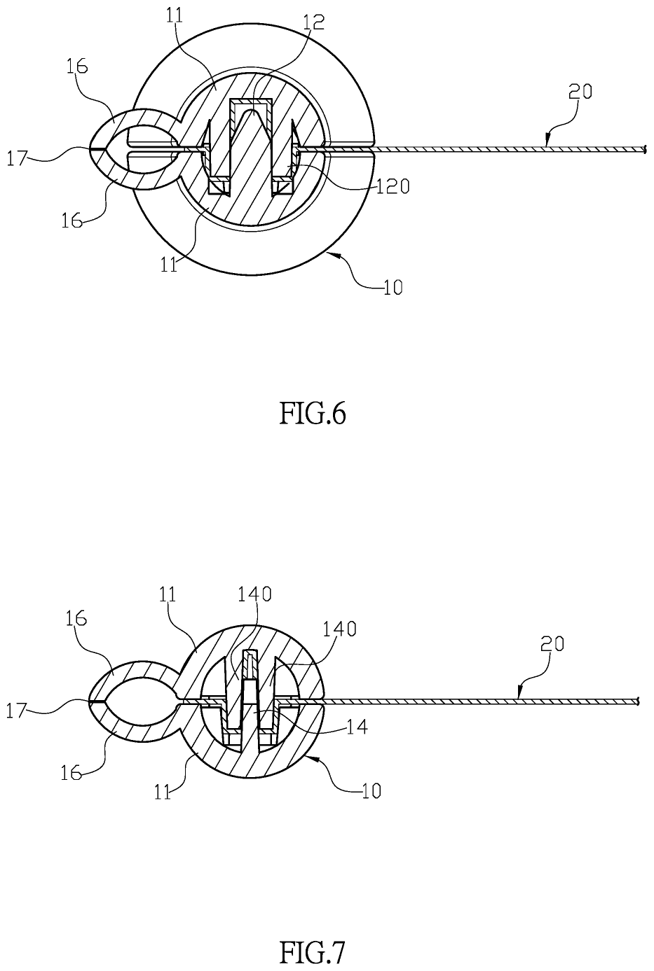

First, please refer to FIG. 1-FIG. 7. The flag holder assembly comprises a flag holder 10 and a flag 20. The flag holder 10 has a pair of casing portions 11, an inner surface of one of the casing portion 11 has a plurality of positioning pins 12, a plurality of first fastening portions 13 and at least one first clamping lip 14. An inner surface of another the casing portion 11 has a plurality of positioning hole posts 120, a plurality of second fastening portion 130 and at least one second clamping lip 140. Both of the first clamping lip 14 and the second clamping lip 140 respectively have at least one enforcing rib 15 connected to the casing portion 11, and one of the enforcing rib 15 has a concavity 151. When the flag 20 is placed between the two casing portions 11, the positioning hole posts 120 engage with the positioning pins 12 with each second fastening portion 130 locks with each first fastening portion 13 portion to sandwich the flag 20 between the two casing portions 11. With the staggering arrangement of the first clamping lip 14 and the second clamping lip 140, the first clamping lip 14 and the second clamping lip 140 respectively clamp on each side of the flag 20 to bend the flag 20 to increase friction between the flag 20 and the flag holder 10. Both of the two casing portions 11 respectively have a curved elastic member 16 extending and connecting to each other forming a living hinge 17. Since the elastic member 16, the living hinge 17 and the two casing portions 11 are all made monolithically, the flag holder 10 can accept different flags with different thickness.

Furthermore, a top end of each casing portions 11 is expanded as a semispherical shell.

Also, ends of the positioning pins 12 for insertion into the positioning hole posts 120 are tapered.

In addition, the first fastening portion 13 and the second fastening portion 130 are a corresponding locking pair.

Moreover, each casing portion 11 further comprises two second clamping lips 140, and one of the casing portions 11 further comprises a first clamping lip 14 between the two second clamping lips 140.

Also, the first clamping lip 14 further has at least one notch 141,

Additionally, the flag 20 is a cloth flag.

Alternatively, the flag is a plastic flag.

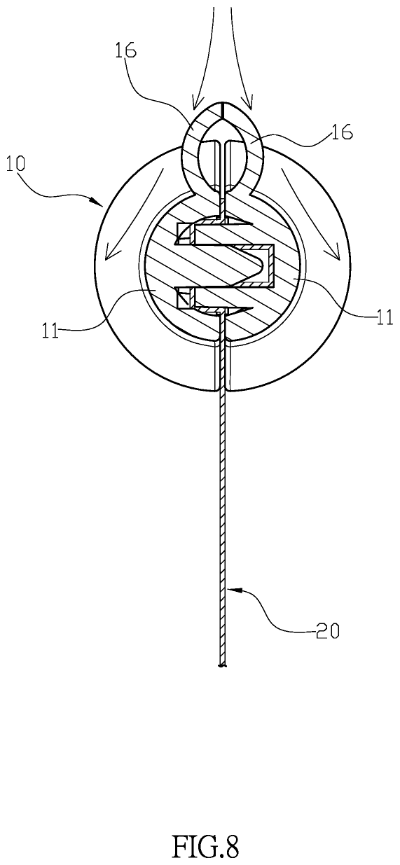

With the structure of the above-mentioned specific embodiment, the following benefits can be obtained: 1. The flag holder 10 only needs to be aligned for closure to clamp the flag 20 in between the two casing portions 11, so that the flag holder 10 has the advantage of being easy to assemble and no need to glue or sew the flag 20. 2. The two casing portions 11 are capable of clamping the flag 20 and forming a strong combined structure, so that the flag is secured while being swayed repeatedly or blown by the wind, therefore, the flag 20 is free to separate from the flag holder 10. 3. The casing portions 11 are connected by the elastic member 16 with the living hinge 17, which enable the flag holder 10 to have the advantages of simple structure and can be integrally formed. 4. One side of the four the flag 20 is bent and clamped between the first clamping lip 14 and the second clamping lip 140, so that the flag holder 10 provides the flag 20 for secure installation, and the flag holder 10 can also have the effect of wind breaking by using the slight extension of the elastic member 16, as shown in FIG. 8. 5. The elastic margin of the elastic member 16 has can accept different thicknesses of the flag 20 to actively adjust the best clamping force, so that the flag holder 10 can hold different types of the flag 20.

Although the present invention has been explained in relation to its preferred embodiment, it is to be understood that many other possible modifications and variations can be made without departing from the spirit and scope of invention as hereinafter claimed.

What is claimed is:

1. A flag holder assembly comprising a flag holder and a flag, wherein:
the flag holder comprises a pair of casing portions, an inner surface of one casing portion having a plurality of positioning pins, a plurality of first fastening portions and at least one first clamping lip, an inner surface of the other casing portion having a plurality of positioning hole posts, a plurality of second fastening portions and at least one second clamping lip; both of the first clamping lip and the second clamping lip respectively having at least one enforcing rib connected to the respective casing portion, and one of the enforcing ribs has a concavity; wherein when the flag is placed between the two casing portions, the positioning hole posts engage with the positioning pins, and each second fastening portion locks with each corresponding first fastening portion to sandwich the flag between the two casing portions; the first clamping lip and the second clamping lip respectively clamp on each side of the flag to bend the flag to increase friction between the flag and the flag holder; both of the two casing portions respectively have a curved elastic member extending and connecting to each other forming a living hinge.

2. The flag holder as claimed in claim 1, wherein a top end of each casing portions is expanded as a semispherical shell.

3. The flag holder as claimed in claim 1, wherein ends of the positioning pins for insertion into the positioning hole posts are tapered.

4. The flag holder as claimed in claim 1, wherein the first fastening portion and the second fastening portion are a corresponding locking pair.

5. The flag holder as claimed in claim 1, wherein each casing portion further comprises two second clamping lips, and one of the casing portions further comprises a first clamping lip between the two second clamping lips.

6. The flag holder as claimed in claim 1, wherein the flag is a cloth flag.

7. The flag holder as claimed in claim 1, wherein the flag is a plastic flag.
